(19) United States
(12) Patent Application Publication
(10) Pub. No.: US 2023/0124435 A1
(43) Pub. Date: Apr. 20, 2023

(54) METHOD AND PROCESS ARRANGEMENT FOR PRODUCING SOLID PRODUCT AND USE

(71) Applicant: Teknologian tutkimuskeskus VTT Oy, Espoo (FI)

(72) Inventors: Ilkka Hannula, VTT (FI); Esa Kurkela, VTT (FI)

(21) Appl. No.: 17/907,392

(22) PCT Filed: Mar. 25, 2021
(86) PCT No.: PCT/FI2021/050208

§ 371 Date: Sep. 26, 2022

(30) Foreign Application Priority Data
Mar. 26, 2020 (FI) 20205303

(51) Int. Cl. C10J 3/54; C10B 49/02; C10B 53/02; C10B 57/16

(52) U.S. Cl. CPC C10J 3/54; C10B 49/02; C10B 53/02; C10B 57/16; C10J 2300/0916; C10J 2300/0956; C10J 2300/1807

(57) ABSTRACT

The invention relates to a method and a process arrangement for producing a solid product, e.g. biochar, by means of a gasification. Bio-based raw material (1) is gasified for forming a product gas (4) and a solid co-product (5) in a gasifier (2), and a gasification temperature is arranged to temperature of 750 - 850° C. for increasing a yield of the solid co-product. Further, the invention relates to the use of the solid co-product.

### FIELD

The application relates to a method defined in claim 1 and a process arrangement defined in claim 11 for producing solid product, such as biochar, in connection with a gasification. Further, the application relates to a use of the solid product defined in claim 18.

### BACKGROUND

Known from the prior art is to gasify different raw materials, biomass and waste raw materials in gasifiers and to produce gasification gases, such as synthesis gas. Biomass gasification is used to convert low-quality biomass residues and waste streams into fuel or synthesis gas which can be used for energy generation or converted to synthetic fuels or chemicals.

Gasification temperature is set to high level for maximising an amount of the synthesis gas in the gasification. Temperature of 850 - 1000° C., such as 870 - 950° C., is used during the gasification. Further, oxygen can be supplied 25 - 40 %, e.g. 25 - 30 %, of stoichiometric oxygen need into the gasification. However, some low-quality feedstocks have ashforming compounds which soften and sinter at the above gasification temperatures. On the other hand, lower temperature leads to lower fuel conversion.

### OBJECTIVE

The objective is to solve the above problems. Further, the objective is to disclose a new type method and process arrangement for producing a solid coproduct in connection with a gasification. Further, the objective is to increase an amount of the solid co-product. Further, the objective is to produce biochar.

### SUMMARY

The method and process arrangement and use are characterized by what are presented in the claims.

In the method and process arrangement, biobased raw material is gasified and a product gas and a solid co-product, such as biochar, is formed in a gasifier.

### BRIEF DESCRIPTION OF THE DRAWING

The accompanying drawing, which is included to provide a further understanding of the invention and constitutes a part of this specification, illustrates some embodiments of the invention and together with the description helps to explain the principles of the invention. In the drawing:

FIG. 1 is a flow chart illustration of a process according to some embodiments.

### DETAILED DESCRIPTION

In a method for producing a solid product, such as biochar, by means of a gasification, the method comprises steps: gasifying bio-based raw material (1) for forming a product gas (4) and a solid coproduct (5), and arranging a gasification temperature to temperature of 750 - 850° C. for increasing a yield of the solid co-product.

A process arrangement for producing a solid product by means of a gasification comprises at least one gasifier (2) for gasifying bio-based raw material (1) to form a product gas (4) and a solid co-product (5), at least one temperature control device for adjusting a gasification temperature to temperature of 750 - 350° C. in order to increase a yield of the solid co-product, and at least one recovery device (3) for recovering the solid co-product in connection with the gasifier.

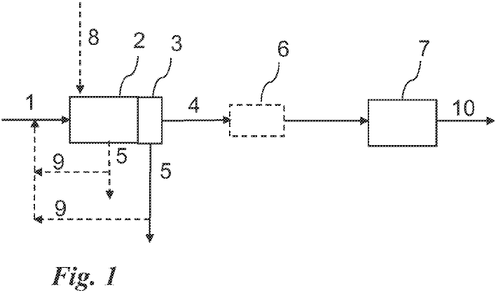

Some embodiments of the method and the process arrangement are shown in FIG. 1.

In this context, the bio-based raw material (1) means any bio-based material, e.g. biomass, recycled bio-based material, bio-based waste material or other bio-based material. In one embodiment, the biobased raw material is selected from the group consisting of biomaterial, biomass, biomass residue, waste material, waste stream, low-quality feedstock and their combinations. In one embodiment, the bio-based raw material comprises ash-forming compounds.

In one embodiment, the temperature is 780 - 830° C. during the gasification.

In one embodiment, an oxidizer (8) is fed to the gasifier to provide a desired temperature during the gasification. In one embodiment, the oxidizer is selected from the group consisting of oxygen, air, steam and their combinations. In one embodiment, oxygen or air is fed 10 - 22 %, in one embodiment 15 - 20 %, of stoichiometric amount of oxygen to the gasifier.

In one embodiment, the gasifier (2) is a circulating fluidized-bed (CFB) gasifier or bubbling fluidized-bed (BFB) gasifier. In one embodiment, the gasifier is a fixed-bed gasifier, where the solid coproduct can be removed from a bottom of the gasifier. Alternatively, any suitable gasifier can be used. In one embodiment, a fluidizing gas which can be any suitable fluidizing gas is used during the gasification in the gasifier. In one embodiment, steam is used during the gasification in the gasifier.

In one embodiment, at least a part of the solid co-product (5) is recirculated back to the gasifixation, such as to a feed of the gasifier. In one embodiment, the process arrangement comprises at least one recirculating device for recirculating at least a part of the solid co-product (5) back to the gasifier (2) . In one embodiment, a part of the solid coproduct, e.g. 1 - 50 w-%, is recirculated back to the gasifier. In one embodiment, a main proportion of the solid co-product, e.g. 50 - 100 w-%, is recirculated back to the gasifier.

In one embodiment, the production of the solid co-product (5), such as biochar, is maximized during gasification. In one embodiment, the yield of the solid co-product is 10 - 20 % of the bio-based raw material carbon content.

Preferably, the solid co-product (5) is recovered. The recovery device (3) can be any recovery device, recovery element, separation device, other suitable device, outlet or the like, by which the solid product can be recovered. In one embodiment, the recovery device can be selected from the group consisting of a filtration device, filter, solid-gas separating device, and their combinations. In one embodiment, the solid co-product is recovered from the gasifier, e.g. via the outlet of the gasifier. In one embodiment, the solid co-product is recovered from a bottom of the gasifier, e.g. as ungasified char. In one embodiment, the solid co-product is recovered after the gasifier. In one embodiment, the solid coproduct is recovered from the recovery device.

In one embodiment, the process arrangement comprises at least one feed inlet for feeding the biobased raw material (1) into the gasifier (2). In one embodiment, the the process arrangement comprises at least one product outlet for discharging the products (4,5) from the gasifier. The feed inlet may be any suitable inlet known per se, e.g. pipe, port or the like. The outlet may be any suitable outlet known per se, e.g. pipe, outlet port or the like.

In one embodiment, the solid co-product (5) can be treated, post-treated or supplied to a next process or a next process step after the gasification. In one embodiment, the solid co-product is a biochar, charcoal or the like.

In this context, the product gas (4) means any gasification gas from the gasification and gasifier, such as gasification gas, synthesis gas or other gas. The product gas can consist of one or more main components. The product gas can comprise carbon dioxide, carbon monoxide, hydrogen and/or methane. Further, the product gas can comprise also other components, e.g. inert components, dust, particulates, water and/or impurities. In one embodiment, the product gas is a fuel gas. In one embodiment, the product gas is a synthesis gas.

In one embodiment, else product gas (4) is treated by a synthesis process to form a final product (10). In one embodiment, the synthesis process is a fuel synthesis, Fischer-Tropsch synthesis or methanation synthesis. Alternatively, other suitable synthesis can be used to treat the product gas.

In one embodiment, the process arrangement comprises at least one synthesis device (7) for treating the product gas (4). In one embodiment, the synthesis device is selected from a fuel synthesis device, Fischer-Tropsch synthesis device or methanation synthesis device. In one embodiment, the process arrangement comprises at least one reformer in which the product gas (4) is treated after the gasifier (2) or before the synthesis device (7). In one embodiment, the product gas is supplied directly or via the reformer to the synthesis device, such as to the Fischer-Tropsch synthesis device or methanation synthesis device.

In one embodiment, the product gas (4) has H₂/CO -ratio which is 1.8 - 2.2, in one embodiment about 2. In one embodiment, the Fischer-Tropsch synthesis is carried out such that the synthesis gas H₂/CO -ratio is 1.8 - 2.2, in one embodiment about 2. In one embodiment, the product gas has H₂/CO -ratio which is 2.8 - 3.2, in one embodiment about 3. In one embodiment, the methanation synthesis is carried out such that the synthesis gas H₂/CO -ratio is 2.8 - 3.2, in one embodiment about 3. Preferably, H₂/CO -ratio of the product gas can be improved when the solid coproduct is separated in connection with the gasification or after the gasification.

In one embodiment, the product gas (4) is filtrated after the gasification. In one embodiment, the process arrangement comprises at least one filtration unit (6) including at least one filtration element. The filtration unit can be arranged before the reformer or before the synthesis device. In one embodiment, the recirculating of the solid co-product (5) is used in the filtration unit to prevent clogging of the filtration element by tars of the product gas.

In one embodiment, the process arrangement comprises at least one electrolysis unit for forming hydrogen. The hydrogen can be supplied to the product gas (4) and/or the synthesis device (7). By means of the electrolysis unit flexilibity can be added in the process.

In one embodiment, the method and process arrangement are based on a continuous process. In one embodiment, the method and process arrangement can be based on a batch process.

In one embodiment, the method and process arrangement can be used and utilized in a production of the biochar, in a purification of the product gas of the gasification, in a production of hydrocarbons, in a Fischer-Tropsch synthesis, in a methanation synthesis, in other processes comprising gasification stage, or their combinations. In one embodiment, the product gas, such as synthesis gas, is further processed to produce hydrogen.

In one embodiment, the solid co-product, such as biochar, is used as a soil conditioner, as a fuel or raw material in combustion process, as a coke in an industrial process, e.g. in steel industry, or in their combinations. In one embodiment, the solid co-product can be saled for external use.

Thanks to the invention, the solid co-product, such as biochar, can be produced. Further, the solid co-product can be maximized in the process.

The method and process arrangement offer a possibility to produce solid product and also product gas with good properties easily, and energy- and cost-effectively. The present invention provides an industrially applicable, simple and affordable way to produce solid and gas products from different raw materials. Further, low-quality feedstocks which are otherwise unusable can be used in this process. Then the range of the feedstocks can be widened in the thermochemical conversions. The method and process arrangement are easy and simple to realize in connection with production processes.

### EXAMPLES

FIG. 1 presents some embodiments of the process for producing solid biochar.

The process arrangement comprises at least one gasifier (2) for gasifying bio-based raw material (1) to form a product gas (4), such as synthesis gas, and a solid co-product (5), such as biochar, and at least one temperature control device for adjusting a gasification temperature to temperature of 750 - 850° C. in order to increase a yield of the solid co-product. The bio-based raw material (1) is gasified in the gasifier (2) for forming the product gas and the solid co-product. An oxidizer (8), e.g. oxygen, air or steam can be fed to the gasifier to provide a desired temperature during the gasification. For example, oxygen or air can be fed 10 - 20 % of stoichiometric amount of oxygen to the gasifier. In FIG. 1, the gasifier can be a circulating fluidized-bed (CFB) gasifier or bubbling fluidized-bed (BFB) gasifier, or alternatively a fixed-bed gasifier.

Further, the process arrangement comprises at least one recovery device (3), which comprises at least one recovery element, for recovering the solid co-product (5) in connection with the gasifier. Alternatively, the solid co-product (5) may be recovered from a bottom of the gasifier (2), e.g. if the fixed-bed gasifier is used. Preferably, the yield of the solid co-product (5) is 10 - 20 % of the bio-based raw material carbon content.

Further, the process arrangement can comprise at least one recirculating device for recirculating at least a part of the solid co-product (5) as a recirculated stream (9) back to the gasifier (2), such as to a feed of the gasifier.

Further, the process arrangement comprises at least one feed inlet for feeding the bio-based raw material (1) into the gasifier (2) and at least one product outlet for discharging the products (4, 5) from the gasifier.

Further, the process arrangement comprises at least one synthesis device (7) selected from a fuel synthesis device, Fischer-Tropsch synthesis device or methanation synthesis for treating the product gas (4) by a synthesis process to form a final product (10). For example, the Fischer-Tropsch synthesis can be carried out such that the synthesis gas H₂/CO -ratio is 1.8 - 2.2, e.g. about 2. For example, the methanation synthesis can be carried out such that the synthesis gas H₂/CO -ratio is 2.8 - 3.2, e.g. about 3.

Further, the process arrangement can comprise at least one reformer in which the product gas (4) is treated after the gasifier (2) or before the synthesis device (7). Then, the product gas can be supplied directly or via the reformer to the synthesis device.

Further, the process arrangement can comprise at least one filtration unit (6) including at least one filtration element for filtrating the product gas (4) after the gasifier (2). In FIG. 1, the filtration unit is arranged before the reformer or the synthesis device (7). The solid co-product (5) can be recirculated in the filtration unit to prevent clogging of the filtration element.

Further, the process arrangement can comprise at least one electrolysis unit for forming hydrogen which can be supplied to the product gas (4) or to the synthesis device (7).

The gasifier, recovery device, recirulating device, filtration unit, reformer, synthesis device and electrolysis unit of the process used in FIG. 1 are known per se in the art, and therefore they are not described in any more detail in this context.

The method and process arrangement are suitable in different embodiments for producing solid products in different gasification processes.

The invention is not limited merely to the examples referred to above; instead many variations are possible within the scope of the inventive idea defined by the claims.

1. A method for producing a solid product by means of a gasification, the method comprising:
gasifying bio-based raw material for forming a product gas and a solid co-product; and
arranging a gasification temperature to temperature of 750 - 850° C. for increasing a yield of the solid co-product; and
feeding an oxygen or air 10 - 22 % of stoichiometric amount of oxygen to the gasification to provide a defined temperature during the gasification.

2. The method according to claim 1, whereinthe temperature is 780 - 830° C. during the gasification.

3-4. (canceled)

5. The method according to claim 1, wherein at least a part of the solid co-product is recirculated back to the gasification.

6. The method according to claim 1, wherein the yield of the solid co-product is 10 - 20% of the bio-based raw material carbon content.

7. The method according to claim 1, whereinthe product gas is treated by a synthesis process to form a final product.

8. The method according to claim 1, wherein the product gas-(4) has H₂/CO -ratio which is 1.8 - 2.2.

9. The method according to claim 1, wherein the product gas-(4) has H₂/CO -ratio which is 2.8 - 3.2.

10. The method according to claim 1, wherein the product gas is filtrated.

11. A process arrangement for producing a solid product by means of a gasification, wherein the process arrangement comprises:
at least one gasifier-(2) for gasifying bio-based raw material to form a product gas and a solid co-product;
at least one temperature control device for adjusting a gasification temperature to temperature of 750 - 850° C. in order to increase a yield of the solid co-product such that an oxygen or air is fed 10 - 22 % of stoichiometric amount of oxygen to the gasification to provide a defined temperature during the gasification; and
at least one recovery device for recovering the solid co-product in connection with the gasifier.

12. The process arrangement according to claim 11, wherein the at least one gasifier-(2) is a circulating fluidized-bed (CFB) gasifier or bubbling fluidized-bed (BFB) gasifier.

13. The process arrangement according to claim 11, whereinthe process arrangement comprises at least one recirculating device for recirculating at least a part of the solid co-product back to the at least one gasifier-(2).

14. The process arrangement according to claim 11, whereinthe process arrangement comprises at least one synthesis device for treating the product gas-by a synthesis process to form a final product.

15. The process arrangement according to claim 14, whereinthe process arrangement can comprise at least one reformer in which the product gas is treated after the at least one gasifier-(2) or before the synthesis device.

16. The process arrangement according to claim 11, whereinthe process arrangement comprises at least one filtration unit for filtrating the product gas.

17. The process arrangement according to claim 11, wherein the process arrangement comprises at least one electrolysis unit for forming hydrogen.

18. A method comprising:
producing a solid co-product, the producing comprising,
gasifying bio-based raw material to form a product gas and the solid co-product;
arranging a gasification temperature to a temperature of 750 - 850° C. to increase a yield of the solid co-product;
feeding an oxygen or air 10 - 22 % of stoichiometric amount of oxygen to the gasification to provide a defined temperature during the gasification;
using the solid co-product as at least one of a soil conditioner, a fuel or raw material in a combustion process, and a coke in an industrial process.

19. The method according to claim 18, wherein the temperature is 780 - 830° C. during the gasification.

20. The method according to claim 18, wherein at least a part of the solid co-product is recirculated back to the gasification.
